(19) United States
(12) Patent Application Publication
(10) Pub. No.: US 2013/0272771 A1
(43) Pub. Date: Oct. 17, 2013

(54) TextBook Study Tool

(71) Applicant: Derek Joseph Tennyson, Atlanta, GA (US)

(72) Inventor: Derek Joseph Tennyson, Atlanta, GA (US)

(21) Appl. No.: 13/726,575

(22) Filed: Dec. 25, 2012

Related U.S. Application Data
(60) Provisional application No. 61/623,051, filed on Apr. 11, 2012.

(51) Int. Cl. B43K 29/00

(52) U.S. Cl. CPC B43K 29/004
USPC 401/16

(57) ABSTRACT

This invention is a non-obvious combination and improvement of existing office tools. It consists of a six inch straight edge with a molded clasp to be used as a grasping bookmark. The end of the molded clasp will be hollowed (as a locking receptacle) to accept and secure a slim and short writing instrument. The writing instrument can be an ink pen, mechanical pencil or a highlighter. All writing instruments will be interchangeable and replacement writing instruments will be separately available. This non-obvious combination and improvement of existing tools produces a novel, unique and patentable product.

### CROSS REFERENCE TO RELATED APPLICATIONS

This application claims the benefit of U.S. Provisional Application, No. 61/623,051, filed Apr. 11, 2012, titled TextBook Study Tool.

### STATEMENT REGARDING FEDERALLY SPONSORED RESEARCH OR DEVELOPMENT

Not Applicable.

### NAMES OF PARTIES IN JOINT RESEARCH

Not Applicable.

### REFERENCE TO SEQUENCE LISTING, A TABLE, OR A COMPUTER PROGRAM LISTING COMPACT DISC APPENDIX

Not Applicable.

### BACKGROUND OF INVENTION

(1) Field of Invention

It is the object of the invention to provide a combination instrument joining a wiring instrument, a book mark and a straight edge. More specifically this multi-use instrument will:

a. Visually delineate text book lines for isolated observation and improved assimilation,

b. Provide a straight edge for clean and even underlining and/or highlighting, c. Provide a writing or highlighting instrument, d. Provide a bookmark to identify place in text, for easy resumption from breaks in studying.

(2) Description of Prior Art

a. It has been encountered where persons use combination tools to employ partial use of the utility of the subject invention, the TextBook Study Tool.

b. Similar tools have partial applications, but none consistent with the non-obvious, combined utility of the TextBook Study Tool.

### BRIEF SUMMARY OF INVENTION

This multi-purpose tool is a non-obvious combination and improvement of existing office tools.

This non-obvious combination of tools will have multiple uses that facilitate the reading of detailed reading material in either textbook or printed page forms.

### BRIEF DESCRIPTION OF THE VIEWS OF THE DRAWING

FIG. 1 is a side view of the subject. It is a simple combination of an insert, a slim, short writing instrument and a receptacle, page grasping straight edge.

FIG. 2 is a top view of the subject. It is a simple combination of the slim, short writing instrument and the receptacle, page grasping straight edge.

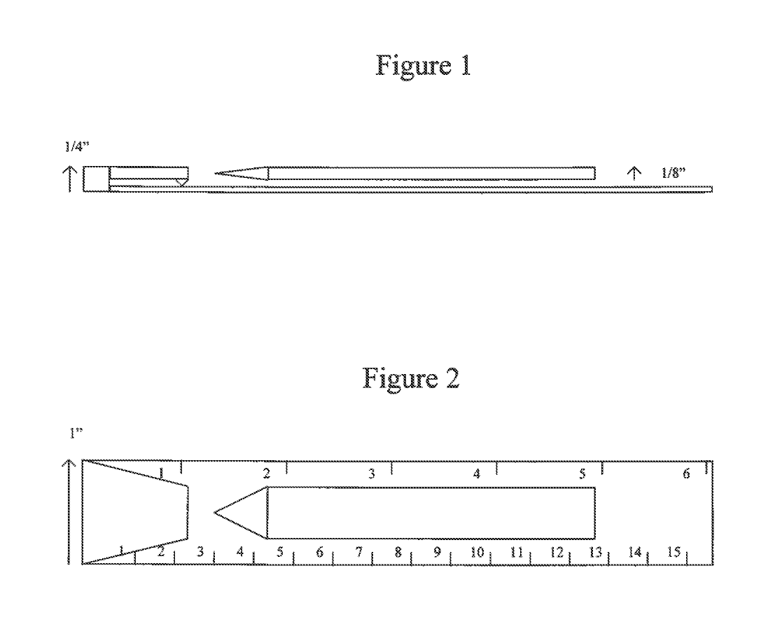

### DETAIL DESCRIPTION OF THE INVENTION

This invention is a non-obvious combination of existing office tools. It consists of a six inch straight edge with a molded clasp to be used as a grasping bookmark.

The end of the molded clasp will be hollowed (as a locking receptacle) to accept a slim and short writing instrument. This writing instrument can be an ink pen, highlighter or mechanical pencil.

All writing instruments will be interchangeable and replacement writing instruments will be separately available.

### SEQUENCE LISTING

Not Applicable.

What is claimed is:

1. A multi-purpose tool combined in a non-obvious fashion, adapted selectively to be used as a writing instrument, a highlighter, a straight edge, a ruler or a bookmark.

2. A multi-purpose combination tool as set forth in claim 1, wherein the improvement includes a straight edge for clean and even underlining and/or highlighting.

3. A multi-purpose combination tool as set forth in claim 1, wherein the improvement includes a straight edge to visually delineates textbook lines for isolated observation and improved assimilation.

4. A multi-purpose combination tool as set forth in claim 1, wherein the improvement includes a six inch ruler can be used for the purposes of any common ruler.

5. A multi-purpose combination tool as set forth in claim 1, wherein the improvement includes an ink pen, mechanical pencil or highlighting instrument with a receiving end that will snap the marking instrument into the combination tool and securely hold the writing instrument.

6. A multi-purpose combination tool as set forth in claim 1, wherein the improvement includes a bookmark that will clasp onto a selected page to identify place in text.
